(19) United States
(12) Patent Application Publication
(10) Pub. No.: US 2005/0073203 A1
(43) Pub. Date: Apr. 7, 2005

(54) Stage for a workpiece

(75) Inventor: Paul Harris, Haverhill (GB)

Correspondence Address: HOUSTON ELISEEVA, 4 MILITIA DRIVE, SUITE 4, LEXINGTON, MA, 02421, US

(73) Assignee: Leica Microsystems Lithography Ltd., Cambridge (GB)

(21) Appl. No.: 10/953,884

(22) Filed: Sep. 29, 2004

(30) Foreign Application Priority Data
Oct. 2, 2003 (GB) GB 03 23 079.4

(51) Int. Cl. H02K 1/00

(52) U.S. Cl. 310/10

(57) ABSTRACT

A stage (10) for a workpiece comprises an upper member (13) for carrying a workpiece holder (15), a lower member (12) and two guide assemblies (16) mounting the upper member (13) on the lower member (12) to be rectilinearly displaceable relative thereto. The lower member (12) is in turn preferably similarly mounted on a fixed base plate (11) by further such guide assemblies (16), the two members (12, 13) being respectively displaceable in an X direction and a Y direction. At least one of the members (12 or 13), but preferably both members and also the base plate (11), is made of a machinable lightweight composite, for example aluminium alloy and silicon carbide, having a coefficient of thermal expansion not exceeding that of the principal material of the guide assemblies by more than substantially 50%, preferably by no more than 30 to 35%.

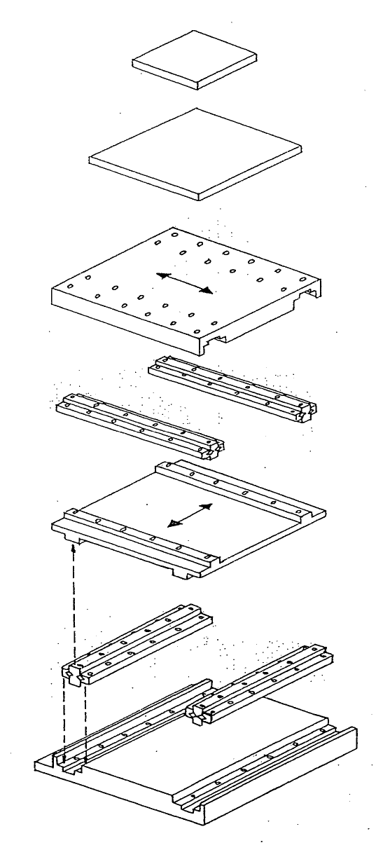

### RELATED APPLICATIONS

This application claims priority of the British patent application 03 23 079.4 which is incorporated by reference herein.

### FIELD OF THE INVENTION

The present invention relates to a stage for a workpiece, especially a stage for translational movement of a workpiece.

### BACKGROUND OF THE INVENTION

Workpiece stages, particularly stages for translation movement of workpieces, but also stages for rotational movement or both translational and rotational movement, are used in a wide variety of machines for processing workpieces by mechanical action, such as cutting, milling and drilling, and by chemical, sonic, optical and electron bombardment action, for example etching, erosion and welding, to name only some more common forms of treatment. In most cases a requirement is present for accurate positioning of the workpiece and thus precisely guided movement. In some instances, particularly micro-treatment of extremely small workpieces, high-precision guidance is necessary with tolerances reduced to the micrometre range or even less. Account has to be taken in these situations of disturbing operational influences, particularly those caused by or associated with temperature change. One such influence is represented by differential thermal expansion arising from use of different materials in close proximity in circumstances where different material properties are essential for different components. For example, movable stage tables should be of lightweight, machinable materials so that they can be produced in complex shapes by machining, yet are sufficiently stiff to withstand loadings and also light in weight to minimise inertial forces to be overcome by table drives. Conversely, guides for such tables need to be made from dense low-wear materials. Aluminum alloy is a common choice for tables and steel a typical choice for guides, especially guides consisting of guide tracks and co-operating guide rollers or balls.

In the case of, for example, stages for translation movement one or more stage tables is or are usually mounted for rectilinear movement by way of sets of track-defining guide rails in strip form. Depending on the particular guide construction, one rail of a set is secured to one table and another rail or two other rails of that set is or are secured to an adjoining table, the rails of the respective tables being in contact by way of caged rollers or balls permitting relative motion of the tables. Such rails, if of steel, are liable to have significantly different thermal characteristics relative to the tables to which they are attached, particularly if the tables are of aluminum. The coefficient of thermal expansion of one specific composition of hard aluminum alloy preferred for stage table construction, namely an alloy containing (by weight) approximately 90% aluminum, 5 to 6% zinc, 2 to 3% magnesium, 1 to 2% copper and the balance of such elements as chromium, iron, manganese, titanium and silicon, is more than double that of the hardened steels preferred for use as guide rails. A guide rail and attached table consequently have thermal expansion characteristics simulating, under the influence of varying temperature, a bimetallic element. Expansion of the table causes bowing of the guide rail. This undesired differential expansion prejudices the precision of the table guidance and ultimately represents a source of error in the accuracy of processing workpieces. Such problems have not been addressed by material selections present in the prior art, for example U.S. Pat. No. 6,252,705, in which it is proposed to use beryllium copper alloy, phosphor bronze, non-magnetic steel alloys or even ceramic for guide rails, the selections, however, being stimulated by considerations relating to magnetic/non-magnetic properties rather than assimilation of coefficients of thermal expansion of adjoining components.

### SUMMARY OF THE INVENTION

It is therefore the principal object of the present invention to minimise differential expansion of adjoining components of a workpiece stage, especially a stage providing translational displacement by way of rectilinear guides, so as to enhance the precision of positioning of a workpiece carried by the stage and to ensure that intended precision is not lost due to exposure of the stage to temperature fluctuation during construction, transportation and operation.

Other objects and advantages of the invention will be apparent from the following description.

According to the present invention there is provided a stage for a workpiece, comprising an upper member for carrying a workpiece or means for supporting a workpiece, a lower member, and guide means mounting the upper member on the lower member to be displaceable relative thereto, at least one of the members being made of a machinable lightweight metal matrix composite having a coefficient of thermal expansion not exceeding that of the material or principal material of the guide means by more than substantially 50%.

Such a reduction in the susceptibility of the guide means and adjoining member or members, for example stage upper and/or lower table, to differential expansion in the case of temperature change significantly reduces any tendency of the guide means to change in shape as a consequence of thermally-induced expansion of the member or members. The guide means, whether of rectilinear, curvilinear, circular or other form, frequently comprises a relatively thin bar or rail with insufficient mass to resist shape-changing forces imposed by expansion of an attached stage table of greater mass. Use of a metal matrix composite allows scope for closer matching of the coefficients of thermal expansion of the table and the guide means, the latter normally made from or principally from a hard-wearing dense metal. The composite can be selected to be suitably light in weight, yet capable of machining, even if diamond-tipped or other specially hardened tools may be needed for that purpose. The light weight of the composite, does not increase or appreciably increase the inertial force to be overcome for the purpose of the relative movement, which in a workpiece stage commonly includes reversals of direction of the members. Retention of light weight in the case of a member or members made from the composite does not, however, compromise stiffness, due to the higher specific modulus of elasticity of the composite compared with that of conventional aluminum alloys.

The coefficient of thermal expansion of the composite employed preferably does not exceed that of the guide means material by more than 30 to 35%. In the case of a composite with a coefficient exceeding that of the guide means material by merely 30 to 35% there may be negligible distortion of the guide means as a consequence of any expansion of the associated member or members made of the composite. Such a composite may have a linear coefficient of thermal expansion of substantially 12 to 17, preferably substantially 12 to 15, microns per meter at 20 degrees Centigrade. If possible, however, i.e. without disadvantage with respect to weight and machineability of the composite and stiffness of the member or members made therefrom, the coefficients of thermal expansion of the composite and the guide means material are approximately the same.

A particularly suitable composite is aluminum alloy matrix containing silicon particles in distribution, the particles preferably being present in the matrix in an amount of substantially 25 to 45 percent by weight. The finely dispersed silicon particles, which may have an average size of 3 microns, impart considerable strength to the matrix body as a whole and result in a significantly lower coefficient of thermal expansion in relation to a correspondingly dimensioned body solely of aluminum alloy. The guide means material, on the other hand, can be steel or predominantly steel, preferably a hardened steel alloy, with, for example, a linear coefficient of thermal expansion of substantially 10 to 13 microns per metre ° C.⁻¹ between 20 and 100 degrees Centigrade.

The advantages of use of this metal matrix composite in the stage construction are particularly evident in a stage for translational workpiece displacement in which the relative movement of the members is substantially rectilinear. The guide means in such a case are then elongate and may take the form of track elements, which are fixed to the members and define tracks, and rollable elements co-operable with the tracks. Guidance accuracy can be enhanced by use of two spaced apart and parallelly extending sets of such track elements. At least some of the track elements can be seated in grooves in the members, which provides particularly secure seating of the track elements without undue risk of warping of the elements, as could occur in the past, due to differential expansion of the material of the elements and that of the member or members with the grooves.

In a simple stage construction the lower member is a fixed base plate and the upper member is thus the sole movable stage component unless, for example, it carries a workpiece support which is separately movable. In a preferred stage construction, however, the stage comprises a fixed base distinct from the upper and lower members and further such guide means, for example track elements and co-operating rollable elements, serving to mount the lower member on the base plate to be displaceable relative thereto. In that case the upper member is preferably displaceable relative to the lower member in a first direction and the lower member displaceable relative to the base plate in a second direction substantially orthogonal to the first direction. Such a stage is thus capable of imparting translation motion to a supported workpiece in X and Y directions. Optimised matching of the coefficients of thermal expansion of the principal adjoining components, i.e. members, base plate and both guide means, can be achieved if not only the two members, but also the base plate are made of the composite.

The invention also embraces a machine comprising a stage with the constructional features outlined above, the benefit of the stage construction being particularly evident in applications where precise guidance of a supported workpiece is highly critical, for example in an electron beam lithography machine. Such machines can be employed for writing patterns on substrates with an accuracy in the nanometre range, in which case even minute deviations in stage guidance accuracy can have a deleterious influence on accuracy of pattern detail to the extent of obliging complicated and time-consuming positional corrections.

### BRIEF DESCRIPTION OF THE DRAWINGS

An embodiment of the present invention will now be more particularly described by way of example with reference to the accompanying drawing, the single FIGURE of which is an exploded perspective view of a workpiece stage embodying the invention.

### DETAILED DESCRIPTION OF THE INVENTION

Referring now to the drawing there is shown, in exploded representation, a workpiece stage 10 for a machine tool or other form of machine, particularly a machine in which precise guidance of a workpiece in X and Y directions is required. Such a machine can be, for example, an electron beam lithography machine in which small-scale integrated circuit layouts are repeatedly written on successive substrates, such as semiconductor wafers. For the purpose of writing the circuit features, each wafer must be displaced in fine increments within very close ranges of tolerances with respect to pitch, roll and yaw so as to avoid offsets in mutually abutting pattern lines. The nature of the machine incorporating the stage and the manner in which the stage is utilised in the machine do not concern the invention as such. However, the stage construction is directed to, inter alia, minimising differential thermal expansion of adjoining stage components and the stage is thus particularly beneficial in the context of machines in which the stage area may be exposed to temperature fluctuations during operation and, more importantly, whilst in build or transportation.

The stage 10 comprises a base plate 11 which is mounted on a substructure (not shown) of the machine to be stationary. A lower table 12 is mounted on the base plate 11 by guide means to be rectilinearly displaceable in Y direction, as indicated by the double-headed arrow on the table. An upper table 13 is in turn mounted on the lower table 12 by further guide means to be rectilinearly displaceable in X direction, as similarly indicated by a double-headed arrow on the table 13. The upper table 13 carries a super plate 14 of ‘Zerodur’ (Trade Mark) glass material, on which are mounted mirror blocks (not shown) respectively oriented in X direction and Y direction and co-operable with laser-based interferometers of an interferometer measuring system for highly accurate position detection. Also mounted on the super plate 14 is a workpiece holder 15, in this instance a wafer chuck, for releasable retention of the workpiece to be processed.

The base plate 11, tables 12 and 13, super plate 14 and holder 15 are depicted in schematic block form. In practice, these elements are complexly shaped by machining to provide locating and mounting points for supported components. Displacement of the tables 12 and 13 in the Y and X directions is undertaken by respective drives, which are not illustrated. The drives can be motorised gear drives, guided cable drives or any other form of drive suitable for providing rectilinear movement.

The guide means mounting the lower table 12 on the base plate 11 and the guide means mounting the upper table 13 on the lower table each consist of two parallelly extending and spaced-apart, five-element guide assemblies 16 of substantially identical construction and each preferably composed of a plurality of track elements and co-operating rollable elements. The track elements consist of a centre rail 16a with a longitudinally extending V-shaped recess at each of two mutually opposite vertical faces and two lateral rails 16b each with a corresponding longitudinally extending V-shaped recess at a vertical face thereof. The boundary surfaces of each recess define two guide tracks. The lateral rails 16b are arranged relative to the centre rail 16a so that each recess of a lateral rail mates with a respective recess of the centre rail to form a channel of approximately square cross-section. The rollable elements are provided in the form of two sets of caged cross rollers (not shown), i.e. rollers with—in alternation—mutually perpendicular axes of rotation. A respective set of rollers is disposed in each channel and runs on the four tracks present in each channel. The two lateral rails 16b of each assembly 16 are in addition disposed in a fixed relationship with one another via the centre rail 16a of the assembly by way of rack-and-pinion couplings (not show) located in the channels. The couplings ensure permanently synchronised motion of the lateral rails 16b relative to the centre rail 16a and prevent creep of the rollers.

Each guide assembly 16 is fixed in place by way of six setscrews securing the centre rail 16a to a respective rib 17 of the lower table 12, two such ribs being provided at each of the two major faces of the table, and six setscrews securing each lateral rail 16b to a respective step 18 of a groove in the upper face of the base plate 11 or lower face of the upper table 13, as the case may be one such groove being provided for each assembly. The specific association of the rails of one of the assemblies 16 with the assigned rib 17 and steps 18 is indicated by dashed-line arrows. Each groove includes a deepened centre portion accommodating, with a clearance, the centre rail 16a of the respective assembly 16. The setscrews penetrate corresponding bores in the centre rails, lateral rails, tables and base plate, certain of the bores being appropriately threaded. The setscrews can be made of titanium to minimise creep in the mounting of the rails.

The rails 16a and 16b of each guide assembly 16 are thus very securely fixed to the base plate 11 and tables 12 and 13 and the material of the rails is in intimate contact with that of the base plate and tables.

The centre and lateral guide rails 16 and 16b of each guide assembly are made from a suitable wear-resistant material, preferably hardened steel. A preferred steel composition includes, for example, 2.00 percent manganese, 0.90 percent carbon, 0.35 percent chromium, 0.25 percent silicon and 0.13 percent vanadium, all percentages being by weight. Such a composition results in a linear coefficient of thermal expansion of 11 to 12 microns per meter at 20 to 100° C. (rising to 12.8 at 500° C.), density of 7.85 g/cm³, hardness of 64 HRC at 100° C. (reducing to 50 at 400° C.) attained after annealing, hardening, quenching and tempering, modulus of elasticity of 210 N/mm² and thermal conductivity of 30.0 W/m.K. Guide rails constructed from such hardened steel, notwithstanding the stated modulus of elasticity, are susceptible by virtue of their elongate and relative thin form to flexure, particularly if subjected to bending stress induced by rigidly attached components having appreciably different coefficient of thermal expansion.

To avoid distortion of the guide assembly elements in this manner, the base plate 11 and tables 12 and 13, which as explained are fastened particularly securely to the guide rails, are each made of a metal matrix composite having a coefficient of thermal expansion matched more closely to that of the constituent steel of the guide rails than in the case of prior art practice, in which aluminum with zinc, magnesium, copper and other alloying elements was commonly used for the base plate and tables. Such a metal matrix composite is, for example, an aluminum and silicon carbide composite based on an aluminum alloy matrix with 27.8 percent by weight of distributed silicon carbide particles having a mean size of 3 microns, the composite being produced by a powder metallurgical process. The composite may be characterised by, for example, a linear coefficient of thermal expansion of 15.5 microns per meter at 20° C., density of 2.88 g/cm³, hardness of 210 (Brinell or Vickers) or 58.3 (Rockwell A), yield tensile strength of 464 MPa, modulus of elasticity of 115 GPa and thermal conductivity of 150 W/m.K. The indicated density and modulus of elasticity of the composite permit design of light tables when compared with unreinforced aluminum alloy, in terms of modal shape and frequency response, which ensures that the drives for the table displacement do not have to overcome appreciably greater inertial forces than in the case of tables of unreinforced aluminum alloy. The composite also imparts a sufficient degree of stiffness to the tables and base plate and can be machined to provide the grooves, ribs and other required mounting or locating points, use of diamond-tipped tools operating at high speed being desirable for the machining process. Compatibility with magnetic field requirements is achieved by demagnetisation of the base plate and tables to acceptable values of residual magnetism, all other materials being nominally non-magnetic. Due to the closer approach of the thermal coefficient of expansion of the aluminum alloy and silicon carbide composite to that of the steel employed for the guide rails of the guide assemblies 16 there is greatly reduced scope for differential expansion between the rails and the base plate 11 or tables 12, 13 and thus a reduced tendency for the plate or tables to induce bowing or other distortion of the rails. Any expansion of the base plate and tables is largely matched by equivalent expansion of the rails. Measurements conducted in relation to a stage with components constructed from the specified materials, in which the stage was located in a vacuum environment of 10⁻⁷ Torr and in a temperature range of 19 to 23° C., showed that, for a mean travel of each the tables 12 and 13 of 85.5 mm, in the respective Y and X directions, measured deviation tolerances for the guidance parameters of pitch, roll and yaw were in the order of magnitude of less than 20 microradians for each of pitch and roll and less than 100 microradians for yaw, the measurements being carried out on a repeatable range basis at graduated positions between the extremes of stroke of the lower table 12 relative to the base plate 11 and the upper table 13 relative to the lower table 12. The results were obtained by measurements carried out at the interferometer mirror blocks. Orthogonality tolerance was measured at less than 100 microradians, height/planarity tolerance at less than 4 microns pk-pk and rectilinearity tolerance at less than 10 microns pk-pk. Tests were also carried out with thermal stressing of the stage to +10-5° C. without significant loss of accuracy, some benefit possibly even being gained from the mild ‘tempering’ of the structure.

The measurement results confirmed that construction of the base plate 11 and tables 12 and 13 from the metal matrix composite described in the example achieves the desired degree of minimisation of differential thermal expansion relative to the material of the guide assemblies specifically when the coefficient of thermal expansion of the composite does not exceed that of the guide assembly material by more than about 50%. This margin can be further reduced by appropriate change to the composition of the composite, subject to maintaining a machining capability and acceptable levels of weight and stiffness. Other metals can accordingly be selected for the matrix and combined with other metallic or non-metallic materials for reinforcing the matrix.

1. A stage for a workpiece, comprising an upper member for carrying a workpiece or means for supporting a workpiece, a lower member, and guide means mounting the upper member on the lower member to be displaceable relative thereto, at least one of the members being made of a machinable lightweight metal matrix composite having a coefficient of thermal expansion not exceeding that of the material or principal material of the guide means by more than substantially 50%.

2. The stage as claimed in claim 1 wherein the coefficient of thermal expansion of the composite does not exceed that of the guide means material by more than 30 to 35%.

3. The stage as claimed in claim 2, wherein the composite has a linear coefficient of thermal expansion of substantially 12 to 15 microns per meter at 20 degrees Centigrade.

4. The stage as claimed in claim 2, wherein the coefficients of thermal expansion of the composite and the guide means material are substantially equal.

5. The stage as claimed in claim 1, wherein the composite is aluminum alloy matrix containing silicon carbide particles in distribution.

6. The stage as claimed in claim 5, wherein the particles are present in the matrix in an amount of substantially 25 to 45 percent by weight.

7. The stage as claimed in claim 1, wherein the guide means material is steel or predominantly steel.

8. The stage as claimed in claim 7, wherein the guide means material is a hardened steel alloy.

9. The stage as claimed in claim 8, wherein the guide means material has a linear coefficient of thermal expansion of substantially 10 to 13 microns per meter at 20 to 100 degrees Centigrade.

10. The stage as claimed in claim 1, wherein the relative displacement of the members is rectilinear.

11. The stage as claimed in claim 10, wherein the guide means comprises track-defining track elements fixed to the members and rollable elements co-operable with the tracks.

12. The stage as claimed in claim 11, wherein the guide means comprises two spaced apart and parallelly extending sets of such track elements.

13. The stage as claimed in claim 11, wherein at least some of the track elements are seated in grooves in the members.

14. The stage as claimed in claim 1, wherein the lower member is a fixed base plate.

15. The stage as claimed in claim 1, comprising a fixed base plate and further such guide means mounting the lower member on the base plate to be displaceable relative thereto.

16. The stage as claimed in claim 15, wherein the upper member is displaceable relative to the lower member in a first direction and the lower member is displaceable relative to the base plate in a second direction substantially orthogonal to the first direction.

17. The stage as claimed in claim 15, wherein the two members and the base plate are made of the composite.

18. The stage as claimed in claim 1, wherein the stage is provided in an electron beam lithography machine.
